(19) United States
(12) Patent Application Publication
(10) Pub. No.: US 2014/0279405 A1
(43) Pub. Date: Sep. 18, 2014

(54) RESIDENTIAL REAL ESTATE APPRAISAL FORM ANALYSIS SYSTEMS AND RELATED METHODS

(71) Applicant: NCIP Holdings, LLC, Kansas City, MO (US)

(72) Inventors: Daniel A. Darnieder, Milwaukee, WI (US); John K. Walstra, Port Washington, WI (US); Chad W. Barker, Greenwood, IN (US); Donna M. Delmonte, San Clemente, CA (US); Jason A. Barile, Indianapolis, IN (US); Anthony R. Ebeyer, Greenwood, IN (US); Aaron N. Shepler, Indianapolis, IN (US)

(73) Assignee: NCIP Holdings, LLC, Kansas City, MO (US)

(21) Appl. No.: 14/216,978

(22) Filed: Mar. 17, 2014

Related U.S. Application Data
(60) Provisional application No. 61/792,554, filed on Mar. 15, 2013.

(51) Int. Cl. G06Q 40/02; G06Q 50/16; G06Q 30/02

(52) U.S. Cl. CPC G06Q 40/025; G06Q 30/0278; G06Q 50/16
USPC 705/38

(57) ABSTRACT

Embodiments of form analysis systems are disclosed herein. Other examples and related methods are also presented herein.

### CROSS-REFERENCE TO RELATED APPLICATION

This application claims the benefit of U.S. Provisional Application Ser. No. 61/792,554, filed on Mar. 15, 2013. The disclosure of the such application is incorporated herein by reference.

### TECHNICAL FIELD

The present disclosure relates generally to residential real estate appraisal reviews, and relates, more particularly, to residential real estate appraisal form analysis systems and related methods.

### BACKGROUND

In the residential real estate lending industry, business decisions are made relying or trusting the contents of one or more appraisal forms, which may have been authored or received from third parties. Thus, lenders must rely on residential real estate appraisal forms received from third party appraisers in order to determine whether to grant or deny a loan request for the appraised property. Reviewing such forms manually can be very time consuming and costly, often requiring a large workforce of reviewers to process large volumes of such appraisal forms. Decreasing review time while maintaining review reliability for such forms, accordingly, can boost efficiency and quality.

Considering the above, further developments can be made to increase the usefulness and efficiency of form analysis systems within the field of residential real estate appraisals.

### BRIEF DESCRIPTION OF THE DRAWINGS

The present disclosure will be better understood from a reading of the following detailed description of examples of embodiments, taken in conjunction with the accompanying figures in the drawings.

FIG. 1 illustrates a diagram of a form review system for analyzing data from a plurality of appraisal forms.

FIG. 2 illustrates a computer suitable for implementing an embodiment of the form review system.

FIG. 3 presents a block diagram of elements that can be part of the computer of FIG. 2.

FIG. 4 illustrates portions of an exemplary form review report generated by the review system.

FIG. 5 illustrates a view of a form builder module of the form review system used to form a template therefor.

FIG. 6 illustrates a view of a portion of the form template as built and organized via the form builder module.

FIG. 7 illustrates a flowchart describing a generic implementation of a form review by the rule engine module of the form review system.

FIG. 8 illustrates an exemplary format and implementation of a reviewer module for analyzing the form review generated by the rule engine module.

FIG. 9 presents a view of a review template module configured for producing a review template for the form review.

FIG. 10 illustrates a view of a question manager module of the form review system for selecting or managing review categories for inclusion or exclusion of rule modules from the form review by the rule engine module.

FIG. 11 illustrates another view of the question manager module for assigning several rule modules to a specific review category.

FIG. 12 illustrates a view of a rule review module configured to trace an implementation of a rule module, such as for development, debugging, or certification thereof.

FIG. 13 illustrates a flowchart of a method for analyzing forms via a form review system.

FIG. 14 illustrates a flowchart for another method for analyzing forms via a form review system.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular hierarchical, sequential, or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DESCRIPTION

In one embodiment, system for analyzing residential real estate appraisal forms comprise a communications module, a question manager module, and a rule engine module. The communications module is configured to receive a first form of the residential real estate appraisal forms, the first form being a residential real estate appraisal form and comprising first form data. The question manager module comprises a rule database, and the rule database contains rule modules for analyzing first form questions about the first form. The rule engine module is coupled to the question manager module and is configured to implement a first review of the first form based on the rule modules and the first form data, and to generate a first review report of the first review of the first form. In the same embodiment, the rule modules comprises a first automated rule set for analyzing a first automated question set of the first form questions. The rule engine module receives the first automated rule set of the rule modules of the rule database, receives the first form data of the first form, and calculates first automated rule conclusions for the first automated rule set based on the first form data, the first automated rule conclusions answering the first automated question set for the first form.

In one example, a method for analyzing residential real estate appraisal forms via a form review system comprises (a) receiving a first form of the residential real estate appraisal forms at a communications module of the form review system, the first form being a residential real estate appraisal form and comprising first form data, (b) accessing a rule database via a question manager module of the form review system, the rule database containing rule modules for analyzing first form questions about the first form, (c) calculating a first review of the first form via a rule engine module of the form review system, based on the rule modules and the first form data from the first form, and (d) generating a first review report of the first review of the first form. The method is implemented using a computer processor configured to execute computer program instructions for the features above. The rule modules comprise an automated rule set for analyzing an automated question set of the first form questions. The first review of the first form via the rule engine module comprises (a) receiving, at the rule engine module, the automated rule set of the rule database, (b) receiving, at the rule engine module, the first form data of the first form, and (c) calculating, with the rule engine module, automated rule conclusions for the automated rule set based on the first form data, the automated rule conclusions answering the automated question set for the first form.

In one example, a method for analyzing residential real estate appraisal forms via a form review system comprises (a) receiving, at a communications module of the form review system, a review request for analyzing a first form, the first form being a residential real estate appraisal form, the review request being from a lender, (b) receiving the first form at the communications module of the form review system from at least one of the lender or an appraiser, the first form comprising first form data, (c) calculating a first review of the first form with a rule engine module of the form review system by implementing rule modules for analyzing, with the first form data, first form questions about the first form, and calculating rule conclusions for the rule modules based on the first form data, (d) generating, with the rule engine module, a first review report of the first review of the first form, the first review report comprising a first fail-type conclusion for a first rule module of the rule modules implemented by the rule engine module, (e) providing the appraiser of the first form with access, via a reviewer module of the form review system, to a subsequent review report presenting at least the first fail-type conclusion for the first rule module, (f) generating an update to the first review report with a first subsequent entry received from the appraiser via the reviewer module with respect to the first fail-type conclusion; and (g) delivering the first review report to the lender only after the update thereof with the first subsequent entry from the appraiser.

Other examples and embodiments within the field of residential real estate appraisals are further disclosed herein. Such examples and embodiments may be found in the figures, in the claims, and/or in the present description, and all examples and embodiments herein are limited to residential real estate appraisal form analysis systems and methods.

Turning to the drawings, FIG. 1 illustrates a diagram of system 1000 for analyzing data from appraisal forms, such as appraisal form 100. Appraisal form 100 can comprise any type of residential real estate appraisal form with datafields that have been pre-filled, such that system 100 can analyze whether the data in such pre-filled datafields conforms to one or more requirements or standards and/or whether at least part of such data is correct or not. In some examples, appraisal form 100 can correspond to a residential real estate form, such as a “Uniform Residential Appraisal Report” (Form 1004) pre-filled with data concerning appraisal of a subject property, and/or can correspond another residential real estate and/or appraisal form.

FIG. 2 illustrates a computer 900 suitable for implementing an embodiment of system 1000. Computer 900 includes a chassis 902 containing one or more circuit boards (not shown), a USB (universal serial bus) port 912, a Compact Disc Read-Only Memory (CD-ROM) and/or Digital Video Disc (DVD) drive 916, and a hard drive 914. A representative block diagram of the elements included on the circuit boards inside chassis 902 is shown in FIG. 3. A central processing unit (CPU) 1010 is coupled to a system bus 1014 in FIG. 3. In various embodiments, the architecture of CPU 1010 can be compliant with any of a variety of commercially distributed architecture families.

System bus 1014 also is coupled to memory 1008 that includes both read only memory (ROM) and random access memory (RAM). Non-volatile portions of memory 1008 or the ROM can be encoded with a boot code sequence suitable for restoring computer 900 (FIG. 2) to a functional state after a system reset. In addition, memory 1008 can include microcode such as a Basic Input-Output System (BIOS). In the depicted embodiment of FIG. 3, various I/O devices such as a disk controller 1004, a graphics adapter 1024, a video controller 1002, a keyboard adapter 1026, a mouse adapter 1006, a network adapter 1020, and other I/O devices 1022 can be coupled to system bus 1014. Keyboard adapter 1026 and mouse adapter 1006 are coupled in the present example to keyboard 904 and mouse 910, respectively, of computer 900. While graphics adapter 1024 and video controller 1002 are indicated as distinct units in FIG. 3, video controller 1002 can be integrated into graphics adapter 1024, or vice versa in other embodiments. Video controller 1002 is suitable for refreshing monitor 906 to display images on a screen 908 of computer 900. Disk controller 1004 can control hard drive 914, USB port 912, and/or CD-ROM or DVD drive 916. In other embodiments, distinct units can be used to control each of these devices separately.

Network adapters 1020 can be coupled to one or more antennas. In some embodiments, network adapter 1020 can be configured for WiFi communication (IEEE 802.11), and/or may be part of a WNIC (wireless network interface controller) card (not shown) plugged or coupled to an expansion port (not shown) in computer 900. Such WNIC card can be a wireless network card built into internal computer 900 in some examples. A wireless network adapter can be built into internal client computer 900 by having wireless Ethernet capabilities integrated into the motherboard chipset, or implemented via a dedicated wireless Ethernet chip, connected through the PCI (peripheral component interconnector) or a PCI express bus. In the same or other embodiments, network adapters 1020 can be configured for communication via other wireless protocols, such as via WPAN, W-CDMA, HSPA, EDGE, WiMAX, LTE, or others. In other embodiments, network adapter 1020 can be a wired network adapter.

Although other components of computer 900 are not shown, such components and their interconnection are well known to those of ordinary skill in the art. Accordingly, further details concerning the construction and composition of computer 900 and the circuit boards inside chassis 902 need not be discussed herein.

When computer 900 is in operation, program instructions stored on hard drive 914, on memory 1008, on a USB drive in USB port 912, and/or on a CD-ROM or DVD in CD-ROM and/or DVD drive 916, can be executed by CPU 1010 (FIG. 3). Such program instructions may correspond to an operating system (OS) such as a Microsoft Windows OS, a Linux OS, and/or a UNIX OS, among others. A portion of such program instructions can be suitable for implementing or carrying out the systems and methods described herein.

Although computer system 900 is illustrated as a desktop computer in FIG. 2, as indicated above, there can be examples where computer system 900 may take a different form factor while still having functional elements similar to those described for computer system 900. In some embodiments, computer system 900 may comprise a single computer, a single server, or a cluster or collection of computers or servers, or a cloud of computers or servers. Typically, a cluster or collection of servers can be used when the demand on computer system 900 exceeds the reasonable capability of a single server or computer, such as, for example, for the central computer system and/or the cloud computer system(s) reference with respect to system 1000 (FIG. 1). In many embodiments, the servers in the cluster or collection of servers are interchangeable from the perspective of appraisal form 100 (FIG. 1) and/or a user of system 1000 (FIG. 1).

Returning to FIG. 1, system 1000 comprises communications module 1900 that can be configured to receive review request 101 with appraisal form 100 comprising datafields 110 that have been pre-filled with form data 111. Communications module 1900 can be similar to network adapter 1020 (FIG. 3) in the example of computer 900 (FIG. 2), or can comprise a module residing in memory 1008 (FIG. 3) and/or executable via computer 900 (FIG. 2) to communicate via network adapter 1020 (FIG. 3).

System 1000 also comprises question manager module 1200, which comprises rule database 1210. Rule database 1210 contains rule modules 1211 for analyzing form questions about one or more residential real estate appraisal forms, such as appraisal form 100. The form questions to be addressed by rule modules 1211 can pertain, for example, to whether any required datafield of datafields 110 has been filled correctly, and/or whether it has been filled at all. Rule modules 1211 are thus the structures by which the form questions for appraisal form 100 can be answered.

System 1000 further comprises rule engine module 1100 coupled to question manager module 1200. Rule engine module 1100 is configured to implement form review 1110 of appraisal form 100 based on form data 111 as applied to rule modules 1211. Rule engine module 1100 also is configured to generate review report 109 comprising information about the form review 1110 carried out by rule engine module 1100.

FIG. 4 illustrates portions of an example of review report 109 generated by rule engine module 1100 with respect to a residential real estate appraisal review. Although review report 109 is shown in FIG. 4 in graphical or print form, review report 109 can be an output file that can contain information encoded, for example, in a markup language format such as XML. In the example of FIG. 4, review report 109 presents header section 401 listing order request information, which can include information identifying lender 11 (FIG. 1), the person or entity that requested form review 1110 (FIG. 1) for appraisal form 100 (FIG. 1), and/or identifying appraiser 12 (FIG. 1), the person or entity that prepared or pre-filled datafields 110 (FIG. 1) of appraisal form 100 (FIG. 1) with form data 111 (FIG. 1). Review report 109 also illustrates score section 402, describing how many rule modules 1211 (FIG. 1) were processed for appraisal form 100 (FIG. 1) by rule engine module 1100 (FIG. 1), how many of such rule modules 1211 (FIG. 1) were evaluated to a pass-type conclusion by rule engine module 1100 (FIG. 1), and how many of such rule modules 1211 (FIG. 1) were evaluated to a fail-type conclusion by rule engine module 1100 (FIG. 1). Review report 109 also comprises review section 403 listing details for such rule modules 1211 (FIG. 1) that were evaluated to a fail-type conclusion by rule engine module 1100 (FIG. 1).

Returning to FIG. 1, in some examples, rule engine module 1100 is configured to grant a pass-type conclusion to those rule modules 1211 that were successfully evaluated during form review 1110, confirming that the corresponding form data 111 conforms to one or more requirements or standards checked by rule modules 1211.

In the same or other examples, rule engine module 1100 is configured to grant a fail-type conclusion to those rule modules 1211 that were could not be successfully evaluated during form review 1110. For instance, the granting of a fail-type conclusion to a rule module granted can denote that its corresponding form data 111 was not completely filled in and/or was incorrectly filled in, that its corresponding form data 111 fails to meet specific requirements or standards therefor checked by rule modules 1211, and/or that its corresponding form data 111 contains information, such as pictures, handwriting, or free-form text that cannot be automatedly evaluated by the rule module.

As seen in FIG. 1, appraisal form 100 can be received by communications module 1900 for processing thereof via form review 1110 by rule engine module 1100. In some examples, appraisal form 100 can be received along with review request 101 from lender 11, the person or entity that requests that form review 1110 be carried out for appraisal form 100. Appraiser 12 can be a residential real estate appraiser, and lender 11 can be a financial or lending institution. There can also be examples where appraisal form 100 can be received from appraiser 12, which can be the person or entity that prepared or otherwise authored appraisal form 100 with form data 111 in datafields 110 thereof.

Appraisal form 100 can be, for example, a file containing information encoded, for instance, in a markup language format such as XML, among others, where system 1000 can thus be configured to identify datafields 110 therein and extract form data 111 therefrom. In some examples, however, appraisal form 100 can need pre-processing prior to extracting form data 111 therefrom. For instance, appraisal form 100 can be a pdf (portable document format) file, and system 1000 can thus be configured to pre-process such pdf file into a proper format for rule engine module 1110, like the markup language format described above, among others. System 1000 can comprise form builder module 1300 in some implementations to perform such pre-processing as needed based on the type or format of appraisal form 100 as received.

In the same or other examples, form builder module 1300 can be configured to generate form template 1310, which can be used by system 1000 as a template for mapping or extracting form data 111 from datafields 110 of appraisal form 100. Form template 1310 can be built via form builder module 1300 with respect to a target appraisal form type by correlating template datafields thereof to specific datafields expected from an input from such target appraisal form type, and can then be stored for use when such an appraisal form of the target form type is received for processing by system 1000. As an example, FIG. 5 illustrates a view of form builder module 1300 as used to generate form template 1310. In the present example, form builder module is shown generating form template 1310 with respect to a Form 1004 for residential real estate appraisal, where a list of form template datafields 5110 can be built to correlate to datafields 110 (FIG. 1) expected from appraisal form 100 (FIG. 1). As an example, form template datafield 5111 is shown selected thereat, and the characteristics thereof can be edited to specify its datafield type, its label text or description, the path ID or location in system 1000 where corresponding data therefor is to be located, and other characteristics with respect to how form template datafield 5111 is to appear at form template 1310. FIG. 6 illustrates a view of a portion of form template 1310 as built and organized via form builder module 1300 for the different form template datafields 5110 thereof. System 1000 can be configured, in preparation for form review 1110, to populate form template datafields 5110 of form template 1310 with form data 111 of corresponding datafields 110 of appraisal form 100 when appraisal form 100 is received and corresponds to the target form type.

FIG. 7 illustrates a flowchart describing a generic implementation of form review 1110 by rule engine module 1100. In particular, several rule modules 72110, such as rule modules 72111, 72112, 72113, and 72115 out of rule modules 1211, can be implemented by rule engine module 1110, and their respective outputs or conclusions can be used to generate review report 109. In some implementations, rule engine module 1100 can be configured to skip implementation of one or more rule modules based on the result or conclusion of a prior rule module. For instance, in one implementation, rule engine module 1100 can be configured such that, if rule module 72111 evaluates to a pass-type conclusion, then rule module 72112 can be evaluated, and so on. In the same implementation, rule engine module 1100 can be configured such that, if rule module 72111 evaluates to a fail-type conclusion, then implementation of one or more or all remaining ones of rule modules 72110 can be skipped. In a different implementation, rule engine module 1100 can be configured such that rule module 72112 is implemented only if rule module 72111 evaluates to a fail-type conclusion. Implementation of form review 1110 can thus not be dynamic and/or or non-linear. The selection of rule modules like rule modules 7210 for form review 1110 will be described further below with respect to review template module 1400.

Rule engine module 1100 can be configured to implement different types of rule modules. For example, rule modules 72110 can comprise an automated rule set having one or more rule modules, such as automated rule module 72111. In particular, automated rule module 72111 is configured to be automatedly implemented by rule engine module 1100 for answering a corresponding automated question about appraisal form 100 that need not require manual input or review by form reviewer 13 (FIG. 1) unless, for example, rule module 72111 were evaluated to a fail-type conclusion by rule engine module 1100. Accordingly, rule engine module 1100 is configured to receive automated rule module 72111 as part of the automated rule set from rule database 1210 and, based on form data 111 received from appraisal form 100, can calculate automated rule conclusion 72115 as one of a pass-type conclusion or a fail-type conclusion with respect to the corresponding question about appraisal form 100. As an example, rule module 72111 can be configured to answer whether a person's name, received in form data 111 of one of datafields 110 from appraisal form 100, corresponds to a target name expected in rule module 72111. If so, then rule engine module 1100 can classify automated rule conclusion 72115 as a pass-type conclusion, where no further input or review from form reviewer 13 (FIG. 1) is needed. Otherwise, rule engine module can classify automated rule conclusion 72115 as a fail-type conclusion, to be presented at review report 109 for further input or review from form reviewer 13 (FIG. 1).

In some examples, when rule engine module 1100 calculates or classifies automated rule conclusion 72115 as a pass-type conclusion for rule module 72111, rule engine module 1100 can configure review report 109 to withhold or otherwise omit, if desired, information about rule module 72111, including its corresponding question and/or conclusion. In the same or other examples, when rule engine module 1100 calculates or classifies automated rule conclusion 72115 as a fail-type conclusion for rule module 72111, rule engine module 1100 can configure review report 109 to present the question corresponding to rule module 72111 denoting the fail-type conclusion therefor. As an example, as seen in FIG. 4 for review report 109, review section 403 comprises rule module question 4031 and rule conclusion 4032 denoting the fail-type conclusion therefor.

In the example of FIG. 7, rule modules 72110 also can comprise a manual rule set having one or more rule modules, such as manual rule module 72112. In particular, manual rule module 72112 is configured to be implemented by rule engine module 1100 to permit form reviewer 13 (FIG. 1) to analyze a corresponding manual question about appraisal form 100, where such manual question is not of a nature or form that can be automatedly implemented by rule engine module 1100. In such instances, rule engine module 1100 can receive manual rule module 72112 as part of the manual rule set from rule database 1210, and can generate manual rule conclusion 72116 for review report 109 to comprise the manual question corresponding to manual rule module 72112 for appraisal form 100. As an example, manual rule module 72112 can relate to information present in other residential real estate forms to which rule engine module 1100 does not have access, prompting form reviewer 13 (FIG. 1) to research such information in such other forms. As another example, manual rule module 72112 can relate to information that rule engine module 1100 may not be configured to decode, such as information contained in pictures or handwriting.

As also shown in FIG. 7, rule modules 72110 also can comprise an assisted rule set having one or more rule modules, such as assisted rule module 72113. In particular, assisted rule module 72113 is configured to be implemented by rule engine module 1100 to permit form reviewer 13 (FIG. 1) to analyze a corresponding assisted question about appraisal form 100, where such assisted question may not of a nature, form, or designation suitable for fully automated implementation by rule engine module 1100. In such instances, rule engine module 1100 can receive assisted rule module 72113 as part of the assisted rule set from rule database 1210, and can gather, from form data 111, assistive data relevant for answering the assisted question of rule module 72113. Rule engine module 1100 can then generate assisted rule conclusion 72117 for review report 109 to comprise the assistive data relevant for answering the assisted question corresponding to assisted rule module 72113. As an example, assisted rule module 72113 can relate to information in form data 111 that rule engine module 1100 may not be configured to decode, such as information contained in pictures, handwriting, or free-form text that cannot be automatedly evaluated by the rule module. In such examples, such pictures, handwriting, or free-form text can be provided in review report 109 as the assistive data for form reviewer 13 (FIG. 1) to address rule module 72113.

As seen in FIG. 1, system 1000 can comprise reviewer module 1500 coupled to rule engine module 1100. Reviewer module 1500 can be configured to identify failed rule modules having fail-type conclusions from form review 1110, and to present subsequent report 1510 with the failed rule modules of form review 1110 or of review report 109 in interactive form for subsequent review thereof by form reviewer 13 and/or appraiser 12. In some examples, form reviewer 13 and appraiser 12 can be the same person or entity, such that system 1000 can be configured to correspond with appraiser 12, rather than another form reviewer 13, to review subsequent report 1510 via reviewer module 1500.

FIG. 8 illustrates an exemplary format and implementation of reviewer module 1500 for analyzing form review 1110 generated by rule engine module 1100. In particular, subsequent report 1510 is shown thereat presenting exemplary rule module 72111 for the reviewer, having recognized it as a failed rule module identified from form review 1110. Subsequent report 1510 can also present rule module question 4031 (FIG. 4) and/or rule conclusion 4032 (FIG. 4) therefor as shown in FIG. 8 to inform the reviewer about the details for the fail-type conclusion calculated by rule review module 1100 for rule module 72111. In the present example, subsequent report 1510 also is configured to present assessment tool 82111 for failed rule module 72111, where assessment tool 82111 comprises a fail option for the reviewer to confirm the fail-type conclusion calculated by rule review module 1100 (FIG. 7) for rule module 72111.

Assessment tool 82111 also comprises a pass option for the reviewer to change or reverse a fail-type conclusion calculated by rule review module 1100 (FIG. 7) during form review 1110 (FIG. 1), and/or to update review report 109 (FIG. 7) accordingly. For example, subsequent report 1510 presents failed rule module 82115 and corresponding assessment tool 82116 therefor, similar to assessment tool 82111 but correlated to rule module 82115. Upon reviewing rule module question 8037 of rule module 82115, the reviewer may understand that the reason for the fail-type conclusion assigned to rule module 82115 is inconsequential, expected, or acceptable, and thus can change such fail-type conclusion into a pass-type conclusion via the pass option of assessment tool 82116 as shown in FIG. 8. Reviewer module 1500 (FIG. 5) may also present commentary section 8038 for the reviewer to enter comments regarding the decision to change the fail-type conclusion of rule module 82111 via assessment tool 82116.

In some examples, the fail option of assessment tool 82111 may be referred to by other corresponding names, such as a confirm option or an accept option, configured to accept the result or conclusion calculated by rule engine module 1100 (FIG. 7) in review report 109 (FIG. 7) for rule module 72111 (FIG. 7). In the same or other examples, the pass option of assessment tool 82111 may be referred to by other corresponding name(s), such as a “toggle” option or a “change” option, configured to change or toggle the result or conclusion calculated by rule engine module 1100 (FIG. 7) in review report 109 (FIG. 7) for rule module 72111 (FIG. 7).

As illustrated back in FIG. 7, rule modules 1211 can comprise corresponding directives that can be presented when rule engine module 1100 calculates fail-type conclusions for corresponding ones of rule modules 1211. For instance, as seen in FIG. 8, subsequent report 1510 is configured to present directive 8035 that describes, for example, the violation that triggered the fail-type conclusion for rule module 72111 and/or a remedy to address such fail-type conclusion. Directive 8035 can thus guide the reviewer with information for determining whether the fail-type conclusion for rule module 7211 should be changed or not via assessment tool 82111.

In the present embodiment, directive 8035 comprises form-field tag 80351 inserted within the base text of the description of directive 8035. In the present example, form-field tag 80351 is correlated to one of datafields 110 (FIG. 7) received from appraisal form 100 (FIG. 7). For instance, form-field tag 80351 can be correlated to datafield 6112 (FIG. 6) of form template 1310 (FIG. 1), as populated from form data 111 (FIG. 7) of appraisal form 100 (FIG. 7). In some examples, such as during form review 1110 (FIG. 1) by rule engine module 1100 (FIG. 1), form-field tag 80351 of directive 8035 of rule module 72111 can be populated with the corresponding information of form data 111 (FIG. 7) such that, when reviewer module 1500 (FIG. 1) presents subsequent report 1510 (FIG. 1), the contents of form-field tag 80351 are presented along and/or within the base text of the description of directive 8035. Directive 8035 also comprises form-field tag 80352, which can be similar to form-field tag 80351, but can be populated instead with the value expected by rule module 72111.

In the present example, directive 8035 of rule module 72111 also comprises error tag 80353, which can be similar to form-field tag 80351. Error tag 80353 can be populated instead, however, with an identifier and/or a location of datafield(s) from datafields 110 (FIG. 1) of appraisal form 100 (FIG. 1) that can be relevant with respect to the fail-type conclusion assigned to rule module 72111 by rule engine module 1100 (FIG. 7).

In the present example, directive 8035 of rule module 72111 also comprises commentary tag 80354, which can be similar to form-field tag 80351. Error tag 80353 can be populated instead, however, with user input from the reviewer with respect to the fail-type conclusion of rule module 72111 and/or the description of directive 8035.

In some embodiments, when subsequent report 1510 is reviewed by the reviewer via reviewer module 1500 (FIG. 1), any changes or input entered therefor can be used by rule engine module 1100 (FIG. 7) and/or reviewer module 1500 to amend or change review report 109 (FIG. 7). For example, as seen in FIG. 4, review report 109 presents directive 8035 for rule module 72111, including tags 80351, 80352, 80353, and 80354, where tag 80354 presents the user input entered therefor by the reviewer in subsequent review 1510 (FIG. 8).

There can be examples where rule engine module 1100 can comprise or be coupled to a synonym table module to assist during evaluation of one or more a rule modules. As an example, during evaluation of rule module 72111 (FIGS. 4, 7, 8) during form review 1110 (FIG. 1), rule engine module 1100 may compare received input data with expected target data. For example, such input data can be similar to the content of form-field tag 80351 (FIG. 4, 8) received from form data 111 (FIG. 1) of appraisal form 100 (FIG. 1), and such target data can be similar to the content of form-field tag 80352 as expected by rule module 72111. Rule engine module 1100 can be configured such that, if such received input data does not match such expected target data, then rule engine module 1110 can determine whether the received input data matches a synonym contained in the synonym table module, and if a match exists, rule engine module 1110 can compare the synonym in the synonym table module with the expected target data. For example, if the received input data contains the text “Tony” and the expected target data is for the text “Anthony,” then rule engine module 1100 can automatically determine via the synonym table that “Tony” is a synonym for “Anthony” and can evaluate rule module 72111 accordingly. As another example, if the received input data contains the text “avg,” “A.V.G.,” “avrg,” etc., then rule engine module 1100 can automatically determine via the synonym table that such received input data is synonym for the text “average” and can evaluate rule module 72111 accordingly. Thus, if rule engine module 1100 matches received input data with a synonym in the synonym table, rule engine module 1110 can evaluate rule module 72111 by comparing the synonym (and not the received input data) with the expected data, and if the comparison is true, rule engine module 1110 can assign rule module 72111 a pass-type conclusion rather than a fail-type conclusion. In the same or other embodiments, rule engine module 1110 can mark the results for rule module 72111 with information regarding such synonym match from the synonym table.

In some implementations, as shown in FIG. 1, system 1000 can be configured to determine that appraiser 12 is the author appraisal form 100, and to provide appraiser 12, rather than another form reviewer 13, with access to subsequent report 1510 for review thereof via reviewer module 1500. Accordingly, reviewer module 1500 can be configured to receive one or more subsequent entries comprising one or more commentaries and/or one or more amendments by appraiser 12 for failed rule modules in review report 109. Reviewer module 1500 also can be configured to update review report 109 accordingly based on the one or more subsequent entries entered by appraiser 12 via reviewer module 1500. Such subsequent entries and updates can be similar to those described above with respect to directive 8035 (FIGS. 4 & 8) and/or assessment tool 82111 (FIG. 8) in some examples. Accordingly, system 1000 can thus be configured to permit appraiser 12 to address via reviewer module 1500 any errors or concerns highlighted by form review 1110 for its own appraisal form 100, and to then forward review report 109 to lender 11 after the subsequent review thereof by appraiser 12. In some situations, the above-described involvement of appraiser 12 in reviewing the results of form review 1110 for its own appraisal form 100 can increase reviewing speed and/or decrease reviewing costs, where appraiser 12 can be the best qualified person or entity to by virtue of having had the experience of authoring appraisal form 100 itself, and by providing an incentive for appraiser 12 to increase or guarantee the quality of appraisal form 100.

As seen in FIG. 1, system 1000 can comprise review template module 1400 configured to produce review template 1410 for form review 1110 of appraisal form 100. Review template 1410 establishes rule module subset 1411 as the set of rule modules, out of rule modules 1211 from question database 1210, to be implemented by rule engine module 1100 during form review 1110 of appraisal form 100. In particular, review template module 1400 can establish and forward rule module subset 1411 to rule engine module 1100 without required modification of any rule module thereof in question database 1210. Accordingly, at least some of rule modules 1211 in question of database 1210 can be selected into different rule module subsets via review template module 1400, making such rule modules 1211 reusable without modification for different types of appraisal forms other than appraisal form 100.

To illustrate the above, system 1000 also can be configured to receive appraisal form 105 and to generate review report 108 therefor via rule engine module 1100. In some examples, appraisal form 105 can be similar to appraisal form 100, but can differ therefrom, for instance, by comprising a different residential real estate and/or or appraisal form type. Nevertheless, one or more rule modules 1211 of question database 1210 can still be reused, without modification thereof, by rule engine module 1100 when generating respective review reports 109 and 108. Thus, review template module 1420 can produce review template 1420, which can be similar to review template 1410, but establishes instead rule module subset 1421 as the set of rule modules, out of rule modules 1211 from question database 1210, to be implemented by rule engine module 1100 during the review of appraisal form 105.

In particular, either of review template 1410 for appraisal form 100 or review template 1420 for appraisal form 105 can select rule module 12111 from question database 1210 to be included as part of their respective rule module subsets 1411 or 1421 to be fed to rule engine module 1100 without having to modify rule module 12111. Such features permit decreasing development and maintenance costs, because form reviews like form review 1110 can be implemented by selecting and reusing existing rule modules out of question database 1210 without having to develop new software from scratch and/or without having to recode existing software code for each individual rule or question desired to be addressed by a particular form review.

FIG. 9 presents a view of review template module 1400 configured for producing review template 1410 for form review 1110. In the present example, review template module 1400 comprises rule database list 9100 presenting at least a portion of rule modules 1211 selectable from of rule database 1210. Review template module 1400 also presents review template list 9200, listing rule module subset 1411 of review template 1410 in sequential order. Review template module 1400 is configured to permit selection of the rule modules listed in rule database list 9100 and arrangement thereof into review template list 9200 to generate review template 1410 and rule module subset 1411 thereof. For instance, rule module 12111 can be selected from rule database list 9100 and placed into review template list 9200 to select it as part of rule module subset 1411. Similarly, rule module 92111 can be selected from rule database list 9100 and placed into review template list 9200 to select it as part of rule module subset 1411. The location, sequence, and/or arrangement of the rule modules selected into review template list 9200 for review template 1410 can be rearranged as desired, such as via a drag and drop mechanism.

In the same or other examples, one or more of the rule modules selected for review template 1410 can be configured to be skipped via review template module 1400 based on the result of another rule module. For instance, relative to each other, rule modules 92111 and 12111 can be respectively defined as primary and secondary based on their arrangement within section 9210 of review template 1410, thereby directing rule engine module 1100 to skip rule module 12111 and/or other rule modules in section 9210 during form review 1110 (FIG. 1) if rule module 92111 (FIG. 9) evaluates to a fail-type conclusion.

As seen in FIG. 9, review template module 1400 can be configured to present or set one or more characteristics of the rule modules selected for review template 1410. For example, as shown in review template list 9200, rule module 9211 can be configured such that, if the answer to question 92112 of rule module 9211 is “false,” then rule module 9211 will be evaluated by rule engine module 1100 to a pass-type conclusion during form review 1110 (FIG. 1). To the contrary, if the answer to question 92112 of rule module 9211 is “true,” then rule module 9211 will be evaluated by rule engine module 1100 (FIG. 1) to a fail-type conclusion during form review 1110 (FIG. 1). A vice-versa arrangement also can be configured for rule module 9211 if desired, such as seen with respect to rule module 12111 (FIG. 9). As another example, as shown in review template list 9200, rule module 9211 can be configured such that, if the answer to question 92112 evaluates to a fail-type conclusion, then subsequent rule modules of section 9210 will be aborted or skipped. As yet another example, as seen in review template list 9200, rule module 9211 can be configured such that if the answer to question 92112 evaluates to a fail-type conclusion, rule module 92111 will be visible or shown as part of review report 109 (FIGS. 1, 4), such as presented in FIG. 4 with respect to rule module 72111.

In some embodiments, as shown in FIG. 1, review template module 1400 can be configured to include or exclude one or more of rule modules 1211 from form review 1110 based on one or more review categories 1450 desired or requested for form review 1110. For instance, review categories 1450 may be received along with review request 101 for appraisal form 100, and review template module 1400 can then identify therefrom, for inclusion or exclusion, one or more of rule modules 1211 that pertain to the requested review categories 1450. Accordingly, review categories 1450 can be used to request that review template module 1400 include, such as in addition to rule module subset 1411 of review template 1410, specific ones of rule modules 1211 that pertain to review categories 1450. Similarly, categories 1450 can be used to request that review template module 1400 exclude, such as from rule module subset 1411, specific ones of rule modules 1211 that pertain to review categories 1450. Thus, specific ones of rule modules 1211 can be dynamically included in or excluded from form review 1110 without requiring modification of such rule modules 1211 and/or of review template 1410.

Review categories 1450 can be related to different classifications regarding which of rule modules 1211 to implement. Such classifications can comprise, for example, a geographic classification, a product classification, a customer classification, an industry classification, and/or a checklist classification.

The geographic classification can be used to include or exclude specific ones or rule modules 1211 with respect to requirements correlated to a specific geographic location from review request 101. For instance, where appraisal form 100 pertains to an appraisal of a property located in Arizona, review categories 1450 will cause rule modules for questions specific to Arizona to be included, and will cause rule modules for questions specific to other states to be excluded.

Similarly, the product classification can be used to include or exclude specific ones or rule modules 1211 with respect to requirements correlated to specific products to be reviewed from review request 101. Such products are based on or defined by specific form(s) or form type(s) correlated to such products, As an example, if review request 101 requests review for a product where appraisal form 100 consists of a “Form 1004”, review categories 1450 will cause rule modules for questions specific to such “Form 1004” to be included, and will cause rule modules for questions specific to other form types of residential real estate appraisal forms to be excluded.

The customer classification can be used to include or exclude specific ones or rule modules 1211 with respect to requirements correlated to a specific customer or client for which appraisal form 100 is to be reviewed, such as lender 11. Thus, where such customer is a specific lending institution, review categories 1450 will cause rule modules for questions specific to such specific lending institution to be included, and will cause rule modules for questions specific to other lender clients to be excluded.

The industry classification can be used to include or exclude specific ones of rule modules 1211 with respect to requirements correlated to a specific segment of an industry with respect to which appraisal form 100 is to be reviewed. As an example, where appraisal form 100 is a residential real estate appraisal form to be reviewed with respect to an FHA loan request, review categories 1450 will cause rule modules for questions specific to FHA loans to be included, and will cause rule modules for questions specific to other types of loans (and other forms) for other residential real estate appraisals to be excluded.

The checklist classification can be used to include specific ones of rule modules 1211 grouped together as a checklist for review based on, for example, a specific combination required by a client. In some examples, such combination may be requested via review request 101 or determined from review request 101. Thus, such corresponding checklist of specific one(s) of rule modules 1211 can be included in review report 109 and/or in subsequent report 1510 for review by appraiser 12, form reviewer 13, and/or lender 11 as requested or needed. In some examples, the checklist classification can correspond to specific one(s) of rule modules 1211 that need not be automatedly processed by rule engine 1100. For instance, such identified rule modules 1211 can be similar to manual rule module 72112 (FIG. 7) as described above, and/or can present one or more checklist item(s) to be checked via a directive similar to directive 8035 (FIG. 8).

In some examples, question manager module 1200 can be configured to set or manage review categories for rule modules 1211. FIG. 10 illustrates a view of question manager module 1200 for selecting or managing review categories 10450 with respect to whether to include or exclude rule module 12111 (FIG. 1) of rule modules 1211 (FIG. 1) from form review 1110 (FIG. 1). FIG. 11 illustrates another view of question manager module 1200 for assigning several rule modules 11211, out of rule modules 1211, to a specific review category 11451 of review categories 11450. Thus, multiple review categories can be set or managed for a single rule module, as shown in FIG. 10, and/or multiple rule modules can be set or managed for a single review category, as shown in FIG. 11, via question manager module 1200 (FIG. 10). Accordingly, when review categories 1450 are received by rule template module 1400, as described above with respect to FIG. 1, such assigned review categories 10450 (FIG. 10) and/or 11450 (FIG. 11) that match review categories 1450 trigger the inclusion or exclusion, for form review 1110, of their respective rule module 12111 (FIG. 10) or rule module 11451 (FIG. 11).

As seen in FIG. 1, system 1000 comprises rule review module 1600, which is configured to trace implementations of individual ones of rule modules 1211, and which can thus be used, for example, to assist in the development, review, and certification of rule modules 1211 for inclusion in question database 1210.

FIG. 12 illustrates a view of rule review module 1600 configured to trace an implementation of rule module 12500, such as for debugging or certification for inclusion as one of rule modules 1211 in rule database 1210 (FIG. 1). In some examples, rule module 12500 (FIG. 12), rule module 12111 (FIG. 1, 4, 9), and/or rule module 72111 (FIGS. 7, 8) can correspond to and/or be similar to each other. As seen in FIG. 12, rule review module comprises graphical review module 12610 configured to present an interactive decision tree of the logic and flow of rule module 12500. In the present example, rule module 12500 is shown comprising assertion node 12510 for evaluating assertion 12519 of rule module 12500 with respect to question 12501 thereof. Also presented is true-interconnection 12511 extending from assertion node 12510 and corresponding to an instance where assertion node 12510 evaluates to “true,” and false-interconnection 12512 extending from assertion node 12510 and corresponding to an instance where assertion node 12510 evaluates to “false.”

In the present example, rule module 12500 also comprises assertion node 12520 for evaluating assertion 12529 of rule module 12500 with respect to question 12501 thereof, along with true-interconnection 12521 extending from assertion node 12520 and corresponding to an instance where assertion node 12520 evaluates to “true,” and false-interconnection 12522 extending from assertion node 12520 and corresponding to an instance where assertion node 12520 evaluates to “false.” Assertion node 12520 is nested in the present example relative to assertion node 12510, such that assertion node 12520 is either implemented or skipped based on the evaluation of assertion node 12510.

Rule module 12500 can be configured to be traversed such that, if any assertion node thereof evaluates to a fail-type conclusion, rule module 12500 is terminated such that any remaining assertion node within rule module 12500 that is not yet implemented can be skipped. If any assertion node of rule module 12500 evaluates to a pass-type conclusion, then rule module 12500 continues to either a subsequent assertion node or to a pass-type conclusion to terminate rule module 12500. Thus, depending on the logic of the assertion node being evaluated, a true-interconnection or a false-interconnection can extend to a subsequent assertion node, such as node 12520 presenting another assertion to be tested with respect to question 12501 of rule module 12500, can extend to a fail-type conclusion node, such as node 12514 or 12524, or can extend to a pass-type conclusion node, such as node 12523.

Rule review module 1600 (FIG. 1) can be configured to test the logic or flow of rule module 12500 pursuant to a test file or user input targeted to one or more assertions of rule module 12500. In addition, rule review module 1600 can implement rule module 12500 with the test file or user input such that graphical review module 12610 can present a tree traversal plot that, as seen in FIG. 12, distinguishes between untraversed nodes and traversed nodes in the interactive decision tree based on the coverage or path taken for rule module 12500 pursuant to the test file or user input. As an example, graphical review module 12610 is shown in FIG. 12 having highlighted borders for assertion node 12510, false-interconnection 12512, and fail-type conclusion node 12514 to indicate that such elements were traversed pursuant to the test file or user input for rule module 12500, and that the remaining un-highlighted elements were not traversed.

As seen in FIG. 12, rule review module 1600 also can comprise evaluation review module 12620 which, when an assertion node is selected at graphical review module 12610, can be configured to present an evaluation summary showing details of the evaluation of the selected assertion node. For instance, when assertion node 12510 is selected in graphical review module 12610, evaluation review module 12620 can be populated by rule review module 1600 as shown in FIG. 12 with details assertion 12519 and evaluation data therefor.

In the present example, evaluation review module 12620 presents, for assertion node 12510, the content of form datafield 12621 and the content of assertion datafield 12622 with respect to which the content of form datafield 12621 is compared to evaluate assertion 12519 for assertion node 12510. Form datafield 12621 can be, for example, a datafield of an appraisal form, such as appraisal form 100 (FIG. 1), and/or a datafield from a test file or other user input to implement or test assertion node 12510 of rule module 12500. Assertion datafield 12622 can be, for example, a datafield defined within or imported into rule module 12500. For instance, the contents of assertion datafield 12622 can be defined as a static value within rule module 12500, can be defined as a dynamic value based on an output of other assertion module(s) of rule module 12500, and/or can be imported to rule module 12500 from an external source, such as from data included along with review request 101 (FIG. 1).

To illustrate an example of the above, assertion datafield 12622 in FIG. 12 comprises datafield “Target_Name,” which can be correlated to or imported from the borrower name specified by lender 11 (FIG. 1) in the received review request 101 (FIG. 1). Form datafield 12621 comprises datafield “Received_Name,” which can correspond to the borrower name listed in such datafield of appraisal form 100 (FIG. 1). Accordingly, evaluation review module 12620 can access the contents of such datafields for presentation thereof during implementation, review, or certification of rule module 12500. As also shown in FIG. 12, evaluation review module 12620 can also present the operator, “=” in the present example, relative to which the content of assertion datafield 12622 is compared to the content of form datafield 12621.

Rule review module 1600 also comprises form review module 12630 in the present embodiment, where form review module 12630 is configured to present review form 12631 with respect to which rule module 12500 is evaluated. For example, such review form 12631 can be similar to appraisal form 100 (FIG. 1), and/or similar to form template 1310 (FIG. 1) as mapped and populated with respect to a test file or an appraisal form such as appraisal form 100 (FIG. 1). In particular, as shown in FIG. 12, rule review module 1600 is configured such that when assertion node 12510 is selected at graphical review module 12610, a portion of review form 12631 corresponding to assertion node 12519, namely form datafield 12621 in the present example, is highlighted thereat for ease of review or correlation.

Moving on, FIG. 13 illustrates a flowchart for a method 13000 for analyzing forms via a form review system. In some examples, the form review system can be similar system 1000, as presented and described above with respect to FIGS. 1-12. In the same or other examples, the forms can be similar to appraisal form 100 (FIG. 1) and/or appraisal form 105 (FIG. 1).

Method 13000 comprises block 13100 for receiving an appraisal form at a communications module of a form review system. For instance, the appraisal form can be similar to appraisal form 100 (FIG. 1), and the communications module can be similar to communications module 1900 (FIG. 1) as described above with respect to system 1000 (FIG. 1).

Block 13200 of method 13000 comprises accessing a rule database via a question manager module of the form review system, the rule database containing rule modules for analyzing appraisal form questions about the appraisal form. The question manager module can be similar to question manager module 1200 (FIG. 1), and the rule database can be similar to rule database 1210 (FIG. 1) in some examples. In the same or other examples, the modules can be similar to rule modules 1211 (FIG. 1) of rule database 1210 (FIG. 1), as described above with respect to FIGS. 1-12.

Block 13300 of method 13000 comprises calculating a first review of the appraisal form via a rule engine module of the form review system, based on the rule modules and appraisal form data from the appraisal form. In some examples, the first review can be similar to form review 1110 (FIG. 1), and the rule engine module can be similar to rule engine module 1110 (FIGS. 1-12). The appraisal form data can be similar to form data 111 (FIG. 1) in datafields 110 (FIG. 1) of appraisal form 100 (FIG. 1) in the same or other examples.

Block 13400 of method 13000 comprises generating a first review report of the first review of the appraisal form, where the first review report can be similar to review report 109 (FIG. 1) in some examples as described above with respect to FIGS. 1-12. Block 13400 can comprise sub-blocks 13410 and/or 13420 in some implementations. Sub-block 13410 comprises reporting at the first review report a fail-type conclusion calculated by the rule engine module for a first rule module of the rule modules. In some examples, the fail type conclusion can be similar to fail-type conclusion denoted in FIGS. 4 and 8 with respect to rule module 72111 and its corresponding rule conclusion 4032. Returning to FIG. 13, sub-block 13420 of block 13400 can comprise withholding or otherwise omitting from the first review report a pass-type conclusion calculated by the rule engine module for a second rule module of the rule modules. For example, as seen in FIG. 4, review report 109 presents thereat rule modules, such as rule module 72111, whose respective rule conclusions evaluated to a fail-type conclusion during form review 1110 by rule engine module 1100, but withholds or otherwise omits therefrom rule modules that evaluated to a pass-type conclusion during form review 1110.

In some examples, one or more of the different blocks of method 13000 can be combined into a single block or performed simultaneously, and/or the sequence of such blocks can be changed. For example, blocks 13300 and 13400 can be combined into a single block by rule engine module 1100. In the same or other examples, some of the blocks of method 13000 can be subdivided into several sub-blocks if desired. There can also be examples where method 13000 can comprise further or different blocks, such as to implement corresponding features described above with respect to system 1000 in FIGS. 1-12. In addition, there may be examples where method 13000 can comprise only part of the blocks described above. For example, sub-block 13420 can be optional in some implementations.

FIG. 14 illustrates a flowchart for a method 14000 for analyzing forms via a form review system. In some examples, the form review system can be similar system 1000, as presented and described above with respect to FIGS. 1-12. In the same or other examples, the forms can be similar to appraisal form 100 (FIG. 1) and/or appraisal form 105 (FIG. 1).

Block 14100 of method 14000 can comprise receiving, at a communications module of a form review system, a review request from a lender for analyzing an appraisal form. For instance, the appraisal form can be similar to appraisal form 100, and the communications module can be similar to communications module 1900 (FIG. 1) as described above with respect to system 1000 (FIG. 1). The lender can be similar to lender 11 (FIG. 1) in the same or other examples.

Block 14200 of method 14000 comprises receiving the appraisal form at the communications module of the form review system from at least one of the lender or an appraiser of the appraisal form, where the appraisal form can include appraisal form data. As an example, the appraiser can be similar to appraiser 12 (FIG. 1). In some instances, the appraisal form can be received along with the review request of block 14100. In other instances, the appraisal form can be received directly from the appraiser, such as after the review request has been received.

Block 14300 of method 14000 comprises calculating a first review of the appraisal form with a rule engine module of the form review system. In some examples, the first review can be similar to form review 1110 (FIG. 1), and/or the rule engine module can be similar to rule engine module 1100 (FIG. 1), as described above with respect to FIG. 1 and supporting FIGS. 2-12. Block 14300 can comprise sub-blocks 14310 and/or 14320 in some implementations.

300 Sub-block 14310 of block 14300 can comprise implementing, with the rule engine module, rule modules for analyzing, with the appraisal form data received from the appraisal form, appraisal form questions about the appraisal form. In some examples, the rule modules can be similar to rule modules 1211 (FIG. 1) of rule database 1210 (FIG. 1), and/or the appraisal form data can be similar to form data 111 (FIG. 1) from datafields 110 (FIG. 1) of appraisal form 100 (FIG. 1), as described above with respect to FIGS. 1-12.

Sub-block 14320 of block 14300 can comprise calculating, with the rule engine module, rule conclusions for the rule modules based on the appraisal form data. For instance, the rule conclusions can be similar to rule conclusion 4032 for rule module 72111 (FIGS. 4, 7, 8) in some examples.

Block 14400 of method 14000 comprises generating, with the rule engine module, a first review report of the first review of the appraisal form. For instance, the first review report can be similar to review report 109 (FIG. 1) in some examples.

Block 14500 of method 14000 comprises providing the appraiser with access, via a reviewer module of the form review system, to a subsequent review report comprising at least a first fail-type conclusion calculated for a first rule module by the rule engine module. As an example, the reviewer module can be similar to reviewer module 1500 (FIG. 1), and the subsequent review report can be similar to subsequent report 1510 (FIG. 1) provided thereby to appraiser 12 (FIG. 1). The first fail-type conclusion can be similar to rule conclusion 4032 (FIG. 8) presented for rule module 72111 (FIG. 8) via subsequent report 1510 (FIG. 8).

Block 14600 of method 14000 comprises generating an update to the first review report with a first subsequent entry received from the appraiser via the reviewer module with respect to the first fail-type conclusion. In some examples, the first subsequent entry can be similar to one or more of inputs received from appraiser 12 (FIG. 1) via reviewer module 1500 (FIG. 1) for subsequent report 1510 (FIG. 1), such as user input via assessment tool 82111 (FIG. 8), and/or user input via directive 8035 (FIG. 8) or tag(s) thereof.

Block 14700 of method 14000 comprises delivering the first review report to the lender only after the update thereof with the first subsequent entry from the appraiser. In some examples, postponing delivery of the first review report to the lender until subsequent review and update thereof by the appraiser can be beneficial for decreasing the amount of time the lender must spend reviewing or researching errors inconsistencies that could or should have been addressed by the appraiser of the appraisal form previously. In addition, the above-described involvement of the appraiser of the appraisal form in reviewing the results of the appraisal form review for his/her own appraisal form can increase reviewing speed and/or decrease reviewing costs, where the appraiser can be the best qualified person or entity for reviewing or addressing any issues thereof to by virtue of being its author, and by providing an incentive for the appraiser to increase or guarantee the quality of the appraisal form or future appraisal forms.

In some examples, one or more of the different blocks of method 14000 can be combined into a single block or performed simultaneously, and/or the sequence of such blocks can be changed. For example, blocks 14100 and 14200 can be performed simultaneously in some examples. In the same or other examples, some of the blocks of method 14000 can be subdivided into several sub-blocks if desired. There can also be examples where method 14000 can comprise further or different blocks, such as to implement corresponding features described above with respect to system 1000 in FIGS. 1-12. In addition, there may be examples where method 14000 can comprise only part of the blocks described above. For example, blocks 14500, 14600, and/or 14700 can be optional in some implementations.

In some instances, the exemplary modules and/or blocks described above may be implemented for or as part of one or more machines as machine-accessible instructions utilizing any of many different programming codes stored on any combination of machine-accessible media embodied in an application for various devices such as handheld computers, smartphones, portable media players, tablet computers, etc. In addition or alternatively, the machine-accessible instructions may be embodied in a volatile or non-volatile memory or other mass storage device (e.g., a hard disk, a database, a USB drive, a CD, or a DVD). For example, the machine-accessible instructions may be embodied in a machine-accessible medium such as a programmable gate array, an application specific integrated circuit (ASIC), an erasable programmable read only memory (EPROM), a read only memory (ROM), a random access memory (RAM), a flash memory, a magnetic media, an optical media, and/or any other suitable type of medium. The systems, apparatus, methods, and articles of manufacture described herein are not limited in this regard.

Although the residential real estate appraisal form analysis systems and related methods herein have been described with reference to specific embodiments, various changes may be made without departing from the spirit or scope of the present disclosure. Examples of such changes have been given in the foregoing description. Other permutations of the different embodiments having one or more of the features of the various figures are likewise contemplated. Accordingly, the specification and drawings herein are intended to be illustrative of the scope of the disclosure and are not intended to be limiting within the field of residential real estate appraisals. It is intended that the scope of this application shall be limited only to the extent required by the appended claims within the field of residential real estate appraisals.

The residential real estate appraisal form analysis systems and related methods discussed herein may be implemented in a variety of embodiments, and the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A system for analyzing residential real estate appraisal forms, the system comprising:
a communications module configured to receive a first form of the residential real estate appraisal forms,
the first form being a residential real estate appraisal form and comprising first form data;
a question manager module comprising a rule database,
the rule database containing rule modules for analyzing first form questions about the first form; and
a rule engine module coupled to the question manager module and configured to:
implement a first review of the first form based on the rule modules and the first form data; and
generate a first review report of the first review of the first form;
wherein:
the rule modules comprise a first automated rule set for analyzing a first automated question set of the first form questions; and
the rule engine module:
receives the first automated rule set of the rule modules of the rule database;
receives the first form data of the first form; and
calculates first automated rule conclusions for the first automated rule set based on the first form data,
the first automated rule conclusions answering the first automated question set of the first form.

2. The system of claim 1, further comprising:
a form mapper module configured to:
generate a form template with form template datafields for a first form type; and
populate the form template datafields with the first form data of the first form after the first form is received by the communications module and corresponds to the first form type.

3. The system of claim 1, wherein:
the communications module is configured to access the first form data of the first form when the first form is encoded in a markup language format.

4. The system of claim 1, wherein:
the rule engine module is configured to generate the first review report encoded in a markup language format.

5. The system of claim 1, wherein:
the rule engine module is configured to generate the first review report to present at least a portion of the first automated rule conclusions.

6. The system of claim 1, wherein:
the rule modules comprise a first manual rule set for analyzing a first manual question set of the first form questions; and
the rule engine module:
receives the first manual rule set of the rule modules of the rule database; and
generates the first review report to comprise the first manual question set for the first form.

7. The system of claim 1, wherein:
the rule modules comprise a first assisted rule set for analyzing a first assisted question set of the first form questions; and
the rule engine module:
receives the first assisted rule set of the rule modules of the rule database;
gathers first assistive data from the first form data, the first assistive data relevant for answering the first assisted question set; and
generates the first review report to comprise the first assisted rule set and present the first assistive data relevant for answering the first assisted question set.

8. The system of claim 1, wherein:
the first automated rule set comprises:
a first rule module for a first question of the first form questions;
the rule engine module calculates, for the first rule module, a first rule conclusion of the first automated rule conclusions based on the first form data,
the first rule conclusion comprising at least one of a pass-type conclusion or a fail-type conclusion;
and
when the rule engine module calculates that the first rule conclusion comprises the fail-type conclusion:
the first review report presents at least one of the first question or the first rule conclusion.

9. The system of claim 8, wherein:
when the rule engine module calculates that the first rule conclusion comprises the pass-type conclusion:
the first review report omits the first question and the first rule conclusion.

10. The system of claim 8, wherein:
the first rule module comprises a first directive correlated to the first rule conclusion,
the first directive comprising a first directive description describing at least one of a violation of or a remedy to the fail-type conclusion of the first rule conclusion;
and
when the rule engine module calculates that the first rule conclusion comprises the fail-type conclusion:
the first review report presents the first directive for the first question.

11. The system of claim 1, further comprising:
a reviewer module coupled to the rule engine module and configured to:
identify failed rule modules of the first review report,
the failed rule modules corresponding to the first automated rule set of the rule modules whose respective first automated rule conclusions, calculated by the rule engine module, evaluated to a fail-type conclusion;
and
present a subsequent review report with the failed rule modules in interactive form for subsequent review.

12. The system of claim 11, wherein:
the failed rule modules comprise a first failed rule module; and
the subsequent review report is configured to present an assessment tool for the first failed rule module, the assessment tool comprising at least one of:
a fail option to confirm the fail-type conclusion of the first failed rule module; or
a pass option to toggle the fail-type conclusion of the first failed rule module to a pass-type conclusion and update the first review report accordingly.

13. The system of claim 11, wherein:
the communications module is configured to:
provide a residential real estate appraiser with access to the subsequent review report for the subsequent review via the reviewer module, the residential real estate appraiser being an author of the first form;
and
the reviewer module is configured to:
receive one or more subsequent entries from the residential real estate appraiser comprising at least one of one or more commentaries or one or more amendments with respect to the failed rule modules; and
update the first review report accordingly based on the one or more subsequent entries from the residential real estate appraiser.

14. The system of claim 13, wherein:
the communications module is configured to:
receive, from a first lender, a first review request for the first review of the first form by the rule engine module; and
after the first review by the rule engine module, the subsequent review by the residential real estate appraiser, and the update of the first review report based on the one or more subsequent entries from the residential real estate appraiser,
forward the first review report to the first lender.

15. The system of claim 14, wherein:
the communications module is configured to
provide the residential real estate appraiser with access to the subsequent review report via the reviewer module remotely through the internet.

16. The system of claim 11, wherein:
the failed rule modules comprise a first failed rule module; and
the subsequent review report is configured to present a first directive for the first failed rule module rule,
the first directive comprising a first directive description describing at least one of a violation of or a remedy to the fail-type conclusion of the first failed rule module.

17. The system of claim 16, wherein:
the first directive comprises a form-field tag within the first directive description;
the form-field tag is correlated to a first datafield of the first form data;
the rule engine module is configured to populate the form-field tag with the first datafield; and
when the subsequent review report presents the first failed rule module along with the first directive:
the subsequent review report presents the form-field tag, populated with the first datafield, as part of the first directive.

18. The system of claim 16, wherein:
the first directive comprises an error tag within the first directive description;
the error tag is correlated to a first datafield of the first form data; and
the rule engine module is configured to:
populate the error tag with at least one of an identifier of the first datafield or a location of the first datafield in the first form for further review of the first datafield.

19. The system of claim 16, wherein:
the first directive description comprises:
a request for user input with respect to the fail-type conclusion or the first directive for the first failed rule module; and
a commentary tag in the first directive description, configured to be populated with the user input.

20. The system of claim 1, further comprising:
a review template module configured to:
produce a first review template that establishes, out of the rule modules in the rule database and without required modification thereof, a first rule module subset for the first review of the first form.

21. The system of claim 20, wherein:
the review template module is configured to:
produce a second review template that establishes, out of the rule modules in the rule database and without required modification thereof, a second rule module subset for a second review of a second form;
wherein:
the rule database comprises a first rule module of the rule modules; and
when the first and second form comprise different form types, the first rule module is insertable, without required modification thereof, as part of either of:
the first rule module subset for the first review template of the first review; or
the second rule module subset for the second review template of the second review.

22. The system of claim 20, wherein:
the review template module is configured to:
produce a second review template that establishes, out of the rule modules in the rule database and without required modification thereof, a second rule module subset for a second review of a second form;
wherein:
when the first and second forms comprise different form types, the rule engine module is configured to:
implement the first rule module subset, out of the rule modules, for the first review of the first form;
omit the first rule module subset from the second review of the second form;
implement the second rule module subset, out of the rule modules, for the second review of the second form; and
omit the second rule module subset from the first review of the first form.

23. The system of claim 20, wherein:
the review template module is configured to:
produce the first review template to comprise:
a primary rule module of the first module subset; and
a secondary rule module of the first module subset;
and
the rule engine module is configured to:
calculate a primary rule conclusion of the primary rule module; and
skip calculation of the secondary rule module when the primary rule conclusion of the primary rule module comprises a fail-type conclusion.

24. The system of claim 20, wherein:
the review template module comprises:
a rule database list presenting at least a portion of the rule modules in the rule database; and
a review template list configured to present the first rule module subset in sequential order as it is produced;
and
the review template module is configured to:
enable arrangement of individual rule modules from the rule database list into the review template list to produce the first rule module subset; and
enable rearrangement of the individual rule modules within the review template list to produce a sequence for the first rule module subset.

25. The system of claim 20, wherein:
the communications module is configured to:
receive a first review request for the first review of the first form,
the first review request comprising a first review category;
the review template module is configured to:
identify, out of the rule modules in the rule database, one or more first category rule modules pertaining to the first review category; and
at least one of:
include at least one of the one or more first category rule modules, without required modification thereof, along with the first rule module subset for the first review of the first form; or
exclude at least one of the one or more first category rule modules, without required modification thereof, from the first review of the first form.

26. The system of claim 25, wherein:
the review template module is configured to identify the one or more first category rule modules based on at least one of:
a geographic classification of the first review category, where the first rule module subset is selected with respect to requirements correlated to a specific geographic location from the first review request;
a form classification of the first review category, where the first rule module subset is selected with respect to requirements correlated to a specific form to be reviewed for the first review request;
a customer classification of the first review category, where the first rule module subset is selected with respect to requirements correlated to a specific customer of the first review request; or
an industry classification of the first review category, where the first rule module subset is selected with respect to requirements correlated to a specific industry of the first review request.

27. The system of claim 1, further comprising:
a rule review module;
wherein:
the rule modules comprises a first rule module for a first question of the first form questions; and
the rule review module is configured to trace an implementation of the first rule module and comprises:
a graphical review module configured to present an interactive decision tree of the implementation of the first rule module and comprising:
a first assertion node presenting a first assertion of the first rule module to be tested with respect to the first question;
a first true-interconnection extending from the first assertion node and corresponding to an instance where the first assertion node evaluates to true; and
a first false-interconnection extending from the first assertion node and corresponding to an instance where the first assertion node evaluates to false.

28. The system of claim 27, wherein:
the graphical review module is configured to present a tree traversal plot that distinguishes traversed nodes of the interactive decision tree traversed by the implementation of the first rule module from untraversed nodes of the interactive decision tree not traversed by the implementation of the first rule module.

29. The system of claim 27, wherein:
the rule review module is configured to present a traversal of the first rule module based on a test file comprising test input targeted to at least the first assertion of the first rule module.

30. The system of claim 27, wherein:
the first true-interconnection leads to one of:
a second assertion node presenting a second assertion of the first rule module to be tested with respect to the first question;
a first fail-type conclusion node for the first rule module; or
a pass-type conclusion node for the first rule module;
and
the first false-interconnection leads to one of:
a third assertion node presenting a third assertion of the first rule module to be tested with respect to the first question;
a second fail-type conclusion node for the first rule module; or
the pass-type conclusion node for the first rule module.

31. The system of claim 27, wherein:
the graphical review module is further configured to present at the interactive decision tree, along with the first assertion node:
a second assertion node presenting a second assertion of the first rule module to be tested with respect to the first question;
a second true-interconnection extending from the second assertion node and corresponding to an instance where the second assertion node evaluates to true; and
a second false-interconnection extending from the first assertion node and corresponding to an instance where the second assertion node evaluates to false.

32. The system of claim 31, wherein:
the second assertion node is nested relative to the first assertion node such that the second assertion node is at least one of implemented or skipped based on the first assertion node.

33. The system of claim 27, wherein:
the rule review module further comprises:
an evaluation review module configured to present, when the first assertion node is selected, a first evaluation summary showing an evaluation of the first assertion.

34. The system of claim 33, wherein:
the evaluation review module is configured to present, as part of the first evaluation summary:
a content of a first form datafield from the first form data; and
a content of a first assertion datafield of the first assertion node with respect to which the content of the first form datafield is compared to evaluate the first assertion.

35. The system of claim 34, wherein:
the first evaluation summary presents:
a first evaluation operator relative to which the content of the first test datafield is compared to the content of the first form datafield.

36. The system of claim 27, wherein:
the first assertion of the first rule module is configured to be correlated to one or more first form datafields of the first form data; and
the rule review module further comprises:
a form review module configured to present, when the first assertion node is selected, a portion of the first form correlated to the first assertion and presenting the one or more first form datafields in highlighted form.

37. A method for analyzing residential real estate appraisal forms via a form review system, the method comprising using a computer processor configured to execute computer program instructions for:
receiving a first form of the residential real estate appraisal forms at a communications module of the form review system,
the first form being a residential real estate appraisal form and comprising first form data;
accessing a rule database via a question manager module of the form review system,
the rule database containing rule modules for analyzing first form questions about the first form;
calculating a first review of the first form via a rule engine module of the form review system, based on the rule modules and the first form data from the first form; and
generating a first review report of the first review of the first form;
wherein:
the rule modules comprise an automated rule set for analyzing an automated question set of the first form questions; and
calculating the first review of the first form via the rule engine module comprises:
receiving, at the rule engine module, the automated rule set of the rule database;
receiving, at the rule engine module, the first form data of the first form; and
calculating, with the rule engine module, automated rule conclusions for the automated rule set based on the first form data,
the automated rule conclusions answering the automated question set for the first form.

38. The method of claim 37, wherein:
receiving, at the rule engine module, the automated rule set comprises:
receiving a first rule module of the rule modules;
calculating, with the rule engine module, the automated rule conclusions comprises:
calculating a first rule conclusion for the first rule module;
and
generating the first review report comprises one of:
reporting at the first review report the first rule conclusion for the first rule module if the first rule conclusion comprises a fail-type conclusion; or
omitting from the first review report the first rule conclusion for the first rule module if the first rule conclusion comprises a pass-type conclusion.

39. A method for analyzing residential real estate appraisal forms via a form review system, the method comprising using a computer processor configured to execute computer program instructions for:
receiving, at a communications module of the form review system, a review request for analyzing a first form,
the first form being a residential real estate appraisal form,
the review request being from a lender;
receiving the first form at the communications module of the form review system from at least one of the lender or a residential real estate appraiser,
the first form comprising first form data;
calculating a first review of the first form with a rule engine module of the form review system by:
implementing rule modules for analyzing, with the first form data, first form questions about the first form; and
calculating rule conclusions for the rule modules based on the first form data;
generating, with the rule engine module, a first review report of the first review of the first form,
the first review report comprising a first fail-type conclusion for a first rule module of the rule modules implemented by the rule engine module;
providing the residential real estate appraiser of the first form with access, via a reviewer module of the form review system, to a subsequent review report presenting at least the first fail-type conclusion for the first rule module;
generating an update to the first review report with a first subsequent entry received from the residential real estate appraiser via the reviewer module with respect to the first fail-type conclusion; and
delivering the first review report to the lender only after the update thereof with the first subsequent entry from the residential real estate appraiser.
